(19) United States
(12) Patent Application Publication
(10) Pub. No.: US 2019/0118551 A1
(43) Pub. Date: Apr. 25, 2019

(54) Printing System

(71) Applicant: Brother Kogyo Kabushiki Kaisha, Nagoya-shi (JP)

(72) Inventor: Kazuma Hojo, Inazawa-shi (JP)

(21) Appl. No.: 16/137,607

(22) Filed: Sep. 21, 2018

(30) Foreign Application Priority Data
Oct. 25, 2017 (JP) 2017-206188

(51) Int. Cl. B41J 2/325

(52) U.S. Cl. CPC B41J 2/325

(57) ABSTRACT

There is provided a printing system that performs printing on a printing medium conveyed in a conveyance direction, the system including: a printing apparatus that includes an installation portion in which an ink ribbon is removably installed, and a thermal head that heats the ink ribbon installed in the installation portion; a motor; an actuator coupled to the motor and moving the printing apparatus, depending on drive of the motor, in an intersecting direction intersecting with the conveyance direction; and a braking apparatus that brakes rotation of the motor, wherein the brake on the motor is active in a non-electrical-conduction state of the braking apparatus and the brake on the motor is inactive in an electrical conduction state of the braking apparatus.

### CROSS REFERENCE TO RELATED APPLICATION

The present application claims priority from Japanese Patent Application No. 2017-206188 filed on Oct. 25, 2017, the disclosure of which is incorporated herein by reference in its entirety.

### BACKGROUND

### Field of the Invention

The present disclosure relates to a printing system.

### Description of the Related Art

There is known a printing apparatus that performs printing on a printing medium (packaging material, label, and the like) conveyed by a conveyance apparatus, such as a packaging machine. In such a printing apparatus, there is suggested a technique for saving an ink ribbon used for printing. For example, there is known a printing system for reducing an unused area of the ink ribbon. This printing system includes a thermal printer body and a guide rail. The guide rail extends in an orthogonal direction orthogonal to a conveyance direction of the printing medium. The thermal printer body heats the ink ribbon by a thermal head while reciprocating along the guide rail in the orthogonal direction, thus performing printing on areas of the printing medium arranged in the orthogonal direction. Accordingly, the printing apparatus can reduce the unused area of the ink ribbon, making it possible to save the ink ribbon.

### SUMMARY

There is known a printing apparatus including a cassette that is removably installed in the printing apparatus and accommodates an ink ribbon. The printing apparatus performs printing on a printing medium by reeling out the ink ribbon from the cassette installed in the printing apparatus and heating the ink ribbon by a thermal head. When such a printing apparatus is movable in the orthogonal direction orthogonal to the conveyance direction of the printing medium, force may act on the printing apparatus at the time of installation or removal of the cassette to move the printing apparatus in the orthogonal direction. In that case, a user has difficulty in installing or removing the cassette, which is undesirable.

Here, for example, the printing apparatus may move in the orthogonal direction due to drive of a motor. In that case, the motor may be excited to prevent the rotation, thereby preventing the movement of the printing apparatus in the orthogonal direction. However, for example, when the motor is turned off, the motor can not be excited. Namely, for example, when the cassette is installed in or removed from the printing apparatus in a state where an entire system including the printing apparatus and the motor is turned off, the above problem may occur.

An object of the present disclosure is to provide a printing system that allows a user to appropriately install or remove an ink ribbon in or from a printing apparatus.

According to an aspect of the present disclosure, there is provided a printing system configured to perform printing on a printing medium conveyed in a conveyance direction, the system including: a printing apparatus including an installation portion in which an ink ribbon is removably installed, and a thermal head configured to heat the ink ribbon installed in the installation portion; a motor; an actuator coupled to the motor and configured to move the printing apparatus, depending on drive of the motor, in an intersecting direction intersecting with the conveyance direction; and a braking apparatus configured to brake rotation of the motor, wherein the brake on the motor is active in a non-electrical-conduction state of the braking apparatus and the brake on the motor is inactive in an electrical conduction state of the braking apparatus.

The printing apparatus performs printing on the printing medium by heating the ink ribbon by the thermal head while moving in the intersecting direction by the motor and the actuator. When the braking apparatus, which can brake the motor configured to move the printing apparatus in the intersecting direction, is in the electrical conduction state, the brake on the motor is inactive. Namely, when printing is performed in a state where the printing system is turned on, the braking apparatus is in the electrical conduction state and the movement of the printing apparatus is not prevented by the braking apparatus. Meanwhile, when the braking apparatus is in the non-electrical-conduction state, the brake on the motor is active. Namely, for example, when the printing system is turned off, the movement in the intersecting direction of the printing apparatus due to the rotation of the motor is prevented. Accordingly, a user can install or remove the ink ribbon in or from the printing apparatus, for example, in the state where the movement of the printing apparatus is prevented by turning off the printing system. This allows the user to appropriately install or remove the ink ribbon in or from the printing apparatus.

### BRIEF DESCRIPTION OF THE DRAWINGS

FIG. 1 is a perspective view of a printing system 8.

FIG. 2 is a perspective view of a ribbon cartridge 9.

FIG. 3 is a perspective view of a printing apparatus 1 when seen from a front side.

FIG. 4 is a perspective view of the printing system 8 in which the ribbon cartridge 9 is being installed in or removed from the printing system 8.

FIG. 5 is a cross-sectional view taken along the line V-V in FIG. 1 when seen from an arrow direction.

FIG. 6 is a table indicating operation states of a motor 6 and a braking apparatus 6A.

### DESCRIPTION OF THE EMBODIMENTS

<Outline of Printing System 8>

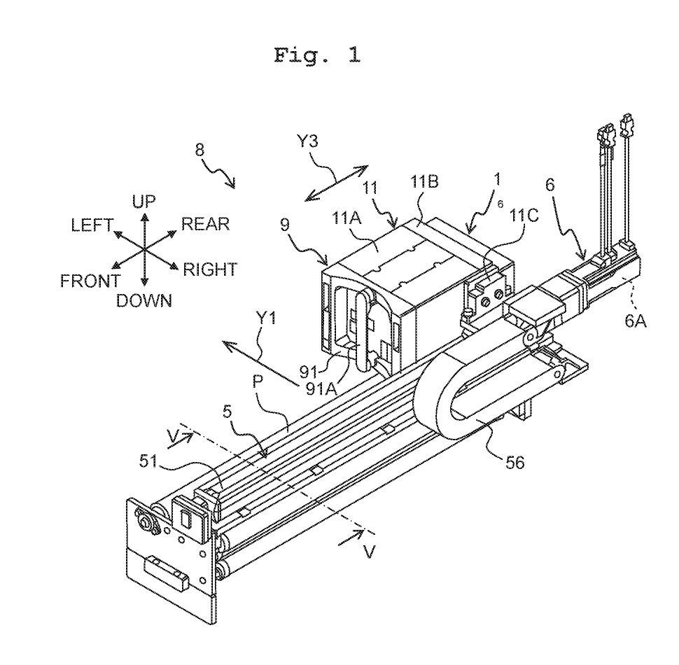

Referring the drawings, an embodiment of the present disclosure is explained. A printing system 8 performs thermal transfer printing. The printing system 8 performs printing on a printing medium conveyed by an external apparatus (not depicted). The external apparatus is exemplified, for example, by a packaging machine conveying a packaging material. For example, the printing system 8 is used by being incorporated into a part of a conveyance line on which the printing medium is conveyed by use of the packaging machine. As depicted in FIG. 1, the printing system 8 includes a printing apparatus 1, an actuator 5, a motor 6, and a braking apparatus 6A. For easy understanding of the drawings, the upper side, lower side, left side, right side, front side, and rear side of components or configurations included in the printing system 8 are defined as follows. The upper side, lower side, left side, right side, front side, and rear side of the printing apparatus 1, the actuator 5, the motor 6, the braking apparatus 6A, and a ribbon cartridge 9 correspond respectively to the upper side, lower side, left obliquely upper side, right obliquely lower side, left obliquely lower side, and right obliquely upper side in FIG. 1. In FIG. 1, a conveyance direction of the printing medium coincides with the left-right direction. The printing medium is conveyed by the external apparatus from the right side to the left side (see, an arrow Y1 in FIG. 1).

<Ribbon Cartridge 9>

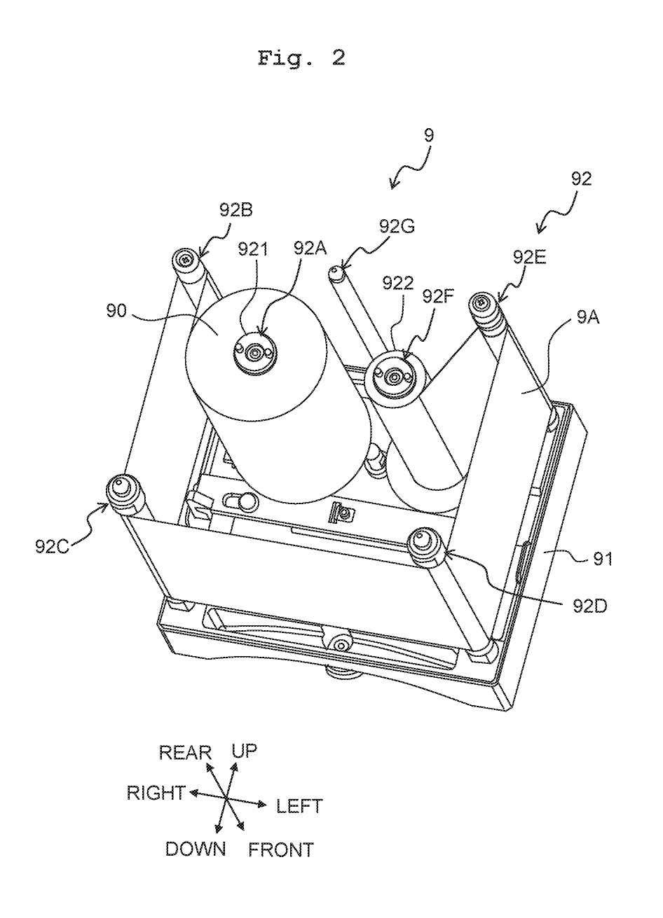

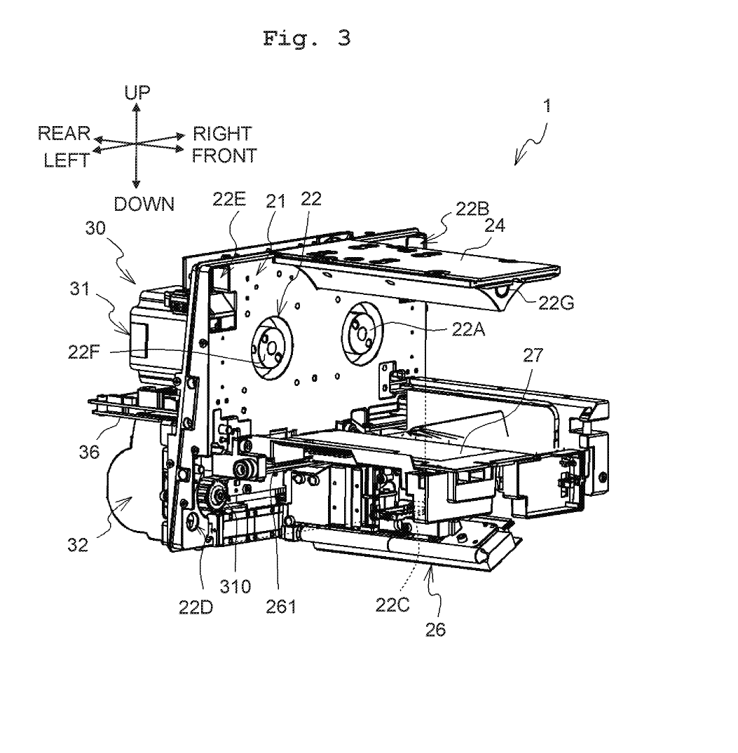

In the printing system 8, the ribbon cartridge 9 is installed in the printing apparatus 1. Printing is performed by heating an ink ribbon 9A (see FIG. 3) reeled out or unreeled from a ribbon roll 90 of the ribbon cartridge 9. As depicted in FIG. 2, the ribbon cartridge 9 includes a base 91 and shafts 92A to 92G (hereinafter collectively referred to as shafts 92). The base 91 has a substantially square plate shape. The shape of the base 91 in plan view is substantially the same as that of an opening of a case 11A (see FIG. 1) of the printing apparatus 1. As depicted in FIG. 1, the front surface of the base 91 is provided with a handle 91A. As depicted in FIG. 2, the shafts 92A to 92G extend rearward from the rear surface of the base 91. Each of the shafts 92A to 92F has a cylindrical shape, and is a spindle capable of rotating around a rotation shaft extending in the front-rear direction. The shaft 92G, which has a cylindrical shape, is secured to the base 91.

The shaft 92A is provided on the upper side of the center in the up-down direction of the base 91 and on the right side of the center in the left-right direction of the base 91. The shaft 92F is provided on the upper side of the center in the up-down direction of the base 91 and on the left side of the center in the left-right direction of the base 91. The shafts 92A and 92F are arranged in the left-right direction. A spool 921 to which a first end of the ink ribbon 9A is connected is attached to the shaft 92A. A spool 922 to which a second end of the ink ribbon 9A is connected is attached to the shaft 92F. In FIG. 2, the ink ribbon 9A is wound in a roll shape around the spool 921, which is attached to the shaft 92A. In the following, the ink ribbon 9A wound in the roll shape is referred to as a ribbon roll 90.

The shaft 92B is provided at the upper right corner of the base 91. The shaft 92C is provided at the lower right corner of the base 91. The shaft 92D is provided at the lower left corner of the base 91. The shaft 92E is provided at the upper left corner of the base 91. The ink ribbon 9A stretched between the spools 921 and 922 is in contact with a part of the circumferential surface of each of the shafts 92B to 92E. The shaft 92G is provided at the upper end of the base 91 and at the center in the left-right direction of the base 91.

<Printing Apparatus 1>

As depicted in FIG. 1, the printing apparatus 1 includes the case 11 having a substantially rectangular parallelepiped shape. The case 11 includes a front-side case 11A and a rear-side case 11B. The case 11A covers a front-side area of the printing apparatus 1 relative to a base plate 21 (see FIG. 3) described below. The front end and the lower end of the case 11A are open. The case 11B covers a rear-side area of the printing apparatus 1 relative to the base plate 21.

As depicted in FIG. 3, the base plate 21 has a substantially square plate shape. Installation portions 22 (see FIG. 3), a thermal head 26 (see FIG. 3), a control board 27 (see FIG. 3), and the like, those of which are described below are provided in an area on the front side of the base plate 21, the area being covered with the case 11A (see FIG. 1). A drive mechanism 30 (motors 31 and 32, a control board 36, and the like, see FIG. 3) described below is provided in an area on the rear side of the base plate 21, the area being covered with the case 11B (see FIG. 1).

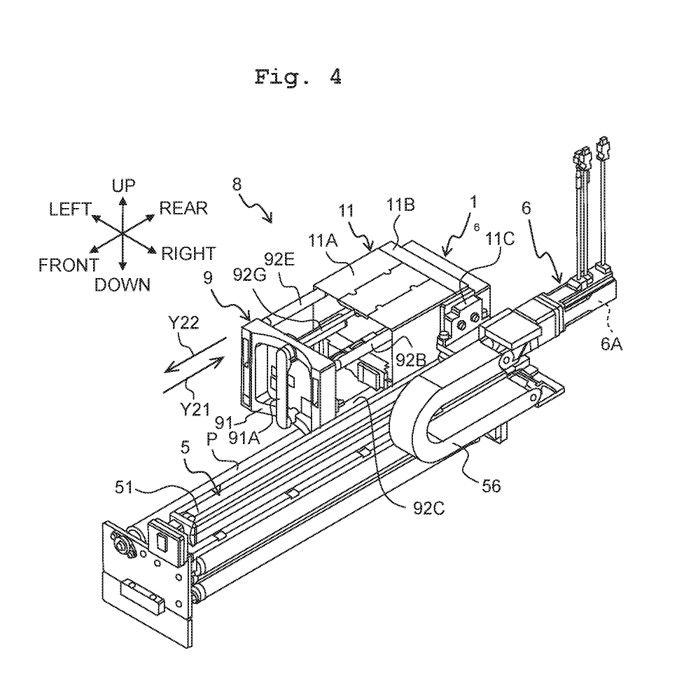

The ribbon cartridge 9 disposed on the front side of the printing apparatus 1 moves rearward (an arrow Y21, see FIG. 4), thereby inserted into the case 11A via the opening at the front end of the case 11A. Accordingly, the ribbon cartridge 9 is removably installed in the printing apparatus 1. For example, a user slides and moves the ribbon cartridge 9 rearward relative to the printing apparatus 1 while holding the handle 91A (see FIG. 4) of the ribbon cartridge 9. This inserts the shafts 92 of the ribbon cartridge 9 into the printing apparatus 1 such that the front ends of the shafts 92 are inserted first thereinto via the opening (see FIG. 1) at the front end of the case 11A of the printing apparatus 1. Accordingly, the ribbon cartridge 9 is installed in the printing apparatus 1. The ribbon cartridge 9 is removed from the case 11A by moving frontward (an arrow R22, see FIG. 4) relative to the printing apparatus 1. Accordingly, the ribbon cartridge 9 is removed from the printing apparatus 1 (see FIG. 4).

As depicted in FIG. 3, the installation portions 22 (22A to 22G), the thermal head 26, the control board 27, and the like are provided in the front surface of the base plate 21. In a state where the ribbon cartridge 9 (see FIG. 2) is installed in the printing apparatus 1, the installation portions 22A to 22G are connected to the shafts 92A to 92G (see FIG. 2) of the ribbon cartridge 9. The installation portion 22A is provided on the upper side of the center in the up-down direction of the base plate 21 and on the right side of the center in the left-right direction of the base plate 21. The installation portion 22F is provided on the upper side of the center in the up-down direction of the base plate 21 and on the left side of the center in the left-right direction of the base plate 21. Each of the installation portions 22A and 22F has a circular shape. The installation portions 22A and 22F are arranged in the left-right direction. When the ribbon cartridge 9 depicted in FIG. 2 is installed in the printing apparatus 1, the ribbon roll 90 wound around the spool 921 connected to the shaft 92A is installed in the installation portion 22A. The spool 922 connected to the shaft 92F is installed in the installation portion 22F.

The installation portion 22B is provided at the upper right corner of the base plate 21. The installation portion 22C is provided at the lower right corner of the base plate 21. The installation portion 22D is provided at the lower left corner of the base plate 21. The installation portion 22E is provided at the upper left corner of the base plate 21. The installation portion 22G is a hole provided at the upper end of the base plate 21 to pass through a column-shaped support portion 24, which extends frontward from the center in the left-right direction of the base plate 21. When the ribbon cartridge 9 is installed in the printing apparatus 1, the shaft 92G of the ribbon cartridge 9 is inserted into the installation portion 22G.

A rotation shaft of the motor 31 described below is connected to the installation portion 22F from the rear side. The installation portion 22F rotates depending on the rotation of the motor 31. A rotation shaft of a motor (not depicted) provided on the rear surface of the base plate 21 is connected to the installation portion 22A from the rear side. The installation portion 22A rotates depending on the rotation of the motor. When the installation portions 22A and 22F rotate in a state where the shafts 92A to 92G (see FIG. 2) of the ribbon cartridge 9 are connected to the installation portions 22A to 22G, the ink ribbon 9A (see FIG. 2) of the ribbon cartridge 9 is conveyed in the printing apparatus 1 such that the ink ribbon 9A is guided between the spools 921 and 922 (see FIG. 2) while being brought into contact with the shafts 92B to 92E.

The thermal head 26 is provided on the lower end of the front surface of the base plate 21 at a position between the installation portions 22C and 22D in the left-right direction. The thermal head 26 is a line thermal head having heating elements arranged linearly in the front-rear direction. The thermal head 26 comes into contact with a part, of the ink ribbon 9A (see FIG. 2) that is unreeled from the ribbon roll 90 of the ribbon cartridge 9 depending on the rotation of the installation portions 22A and 22F, stretched between the shafts 92C and 92D (see FIG. 2), from the upper side. The printing medium and the ink ribbon 9A are sandwiched between the thermal head 26 and a platen roller P (see FIG. 1) disposed on the lower side of the printing apparatus 1, and the ink ribbon 9A is heated by the thermal head 26 in a state where the ink ribbon 9A is pressed against the printing medium.

The thermal head 26 is connected to an endless belt 261. The belt 261 is stretched between a gear 310 provided in the vicinity of the installation portion 22D and a pulley (not depicted) provided in the vicinity of the installation portion 22C. The gear 310 rotates depending on rotation of a motor 32 (see FIG. 7) described below. The belt 261 rotates depending on the rotation of the gear 310. The thermal head 26 is movable in the left-right direction between the vicinity of the installation portion 22C and the vicinity of the installation portion 22D depending on the rotation of the gear 310. The thermal head 26 is movable in the up-down direction between a printing position depicted in FIG. 3 and a standby position (not depicted) positioned on the upper side of the printing position and a retract position positioned on the upper side of the standby position. The thermal head 26 moves in the up-down direction between the printing position and the standby position and the retract position depending on the rotation of a motor (not depicted) provided in the rear surface of the base plate 21.

The control board 27 is provided on the upper side of the thermal head 26. The control board 27 mounts or includes a CPU 27A that performs heating control of the thermal head 26, control of the motor 32 for moving the thermal head 26, control of the motor 31 for rotating the installation portions 22A and 22F, and control of the motor 6 described below (see FIG. 1).

The motors 31 and 32, the motor (not depicted), the control board 36, and the like are connected to the rear surface of the base plate 21. The motors 31 and 32 are stepper motors that rotate in response to input of a pulse signal. The control board 36 includes or mounts driver elements (a transistor, an electrolytic capacitor, and the like) for performing rotation control of the motors 31 and 32 and driver elements (a transistor, an electrolytic capacitor, and the like) for performing heating control of the thermal head 26. Those elements, which are electrically connected to the CPU 27A of the control board 27, are controlled by the CPU 27A. In the following, the motors 31, 32 and the control board 36 are collectively referred to as the drive mechanism 30.

<Actuator 5>

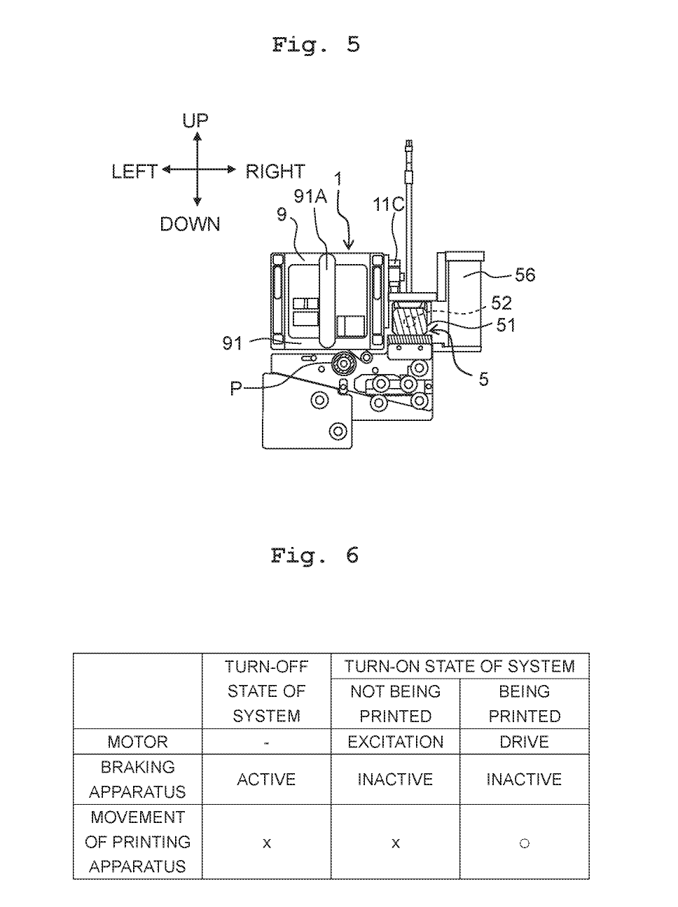

As depicted in FIGS. 1, 4, and 5, the actuator 5 moves the printing apparatus 1 in the front-rear direction (see, an arrow Y3 in FIG. 1) orthogonal to the left right direction, which is the conveyance direction of the printing medium. The actuator 5 includes a support portion 51, a lead screw 52 (see FIG. 5), and a ball screw 52A (see FIG. 5). The support portion 51 has a substantially box shape elongated in the front-rear direction. The lead screw 52 (see FIG. 5), which is disposed inside the support portion 51, extends in the front-rear direction. The rear end of the lead screw 52 is coupled to a rotation shaft of the motor 6. The ball screw 52A is screwed with the lead screw 52, moving in the front-rear direction depending on the rotation of the lead screw 52. A connection portion 11C extending from the right end of the case 11A of the printing apparatus 1 is connected to the ball screw 52A. Movement in the front direction of the ball screw 52A caused by the rotation of the lead screw 52 moves the printing apparatus 1 in the front-rear direction.

A moving direction of the printing apparatus 1 (see, the arrow Y3 in FIG. 1) is parallel to a moving direction (see, the arrows Y21 and Y22 in FIG. 4) of the ribbon cartridge 9 when the ribbon cartridge 9 is installed in or removed from the printing apparatus 1.

<Motor 6>

As depicted in FIGS. 1 and 4, the motor 6 is disposed in the actuator 5 at the rear end of the lead screw 52 (see FIG. 5). The rotation shaft of the motor 6 is coupled to the lead screw 52. A signal wire or signal line extending from the control board 36 of the printing apparatus 1 is connected to the motor 6 after passing through Cableveyor (registered trademark) 56 disposed on the right side of the actuator 5. The motor 6 is driven in response to a signal outputted from the driver elements provided in the control board 36 of the printing apparatus 1.

<Braking Apparatus 6A>

The braking apparatus 6A is an electromagnetic brake capable of braking the rotation of the motor 6. The braking apparatus 6A is connected directly to a power source of the printing system 8. The braking apparatus 6A is switched between an electrical conduction state and a non-electrical-conduction state depending on an on/off state of the power source. In the non-electrical-conduction state of the braking apparatus 6A, namely, in a state where the printing system 8 is turned off, the brake on the motor 6 is active. In that case, the braking apparatus 6A prevents the rotation of the motor 6. In the electrical conduction state of the braking apparatus 6A, namely, in a state where the printing system 8 is turned on, the brake on the motor 6 is inactive. In that case, the braking apparatus 6A does not prevent the rotation of the motor 6.

<Outline of Printing Operation>

As indicated in FIG. 6, in the state where the printing system 8 is turned off, the braking apparatus 6A is in the non-electrical-conduction state and the brake on the motor 6 is active. In that case, the braking apparatus 6A prevents the rotation of the motor 6, thus preventing the rotation of the lead screw 52 of the actuator 5 that is coupled to the rotation shaft of the motor 6. Accordingly, it is possible to prevent movement in the front-rear direction of the printing apparatus 1 that is connected, via the connection portion 11C, to the ball screw 52A screwed with the lead screw 52. For example, a user installs the ribbon cartridge 9 in the printing apparatus 1 by moving the ribbon cartridge 9 rearward relative to the printing apparatus 1 in the state where the movement in the front-rear direction of the printing apparatus 1 is prevented. When the ribbon cartridge 9 is installed in the printing apparatus 1, force directed rearward acts on the printing apparatus 1 due to, for example, the effect of frictional force generated between the ribbon cartridge 9 and the printing apparatus 1. The movement in the front-rear direction of the printing apparatus 1, however, is prevented by the braking apparatus 6A, and thus the printing apparatus 1 does not move rearward if the force caused by the installation of the ribbon cartridge 9 acts thereon.

In the state where the printing system 8 is turned on, the braking apparatus 6A is in the electrical conduction state and the brake on the motor 6 is inactive. When no printing operation is performed, the CPU 27A of the control board 27 of the printing apparatus 1 controls the driver elements of the control board 36 to make the motor 6 have the electrical conduction state and to excite the motor 6. In that case, great static torque is generated on the motor 6 to prevent the rotation of the motor 6, thus preventing the movement in the front-rear direction of the printing apparatus 1. For example, if the user installs the ink ribbon 9A in the printing apparatus 1 and the force caused by the installation of the ribbon cartridge 9 acts on the printing apparatus 1 in the state where the movement in the front-rear direction of the printing apparatus 1 is prevented, the printing apparatus 1 does not move rearward due to the static torque on the motor 6 excited.

The printing apparatus 1 is disposed at a position where the thermal head 26 faces a printing surface of the printing medium conveyed by the external apparatus, in a direction in which the conveyance direction of the printing medium coincides with the left-right direction of the printing apparatus 1. The platen roller P is disposed on the opposite side of the printing apparatus 1 relative to the printing medium. When an instruction for starting the printing operation is inputted, the CPU 27A of the control board 27 of the printing apparatus 1 controls the driver elements of the control board 36 to cause the motor 31 to output the pulse signal, rotating the installation portions 22A and 22F. The rotation of the installation portions 22A and 22F rotates the shafts 92A and 92F of the ribbon cartridge 9 connected to the installation portions 22A and 22F. The ink ribbon 9A is reeled out from the ribbon roll 90 of the spool 921 attached to the shaft 92A, and then wound around the spool 922 attached to the shaft 92E A part of the ink ribbon 9A between the shafts 92C and 92D moves in the same direction as the conveyance direction of the printing medium.

When a conveyance speed of the ink ribbon 9A has reached a predefined speed, the CPU 27A controls the driver elements of the control board 36 to move the thermal head 26 from the retract position to the printing position via the standby position. The thermal head 26 comes into contact with the platen roller P from above via the ink ribbon 9A and the printing medium. The ink ribbon 9A is pressed against the printing surface of the printing medium depending on the movement of the thermal head 26. The platen roller P comes into contact with a surface of the printing medium on the side opposite to the printing surface, pressing the ink ribbon 9A and the printing medium against the thermal head 26. The CPU 27A controls the driver elements of the control board 36 to heat the thermal head 26. This transfers the ink of the ink ribbon 9A to the printing surface of the printing medium, thereby executing printing of an image to be printed.

The CPU 27A controls the driver elements of the control board 36 as needed, and causes the motor 6 to output the pulse signal. The motor 6 rotates the lead screw 52, moving the printing apparatus 1 in the front-rear direction. Accordingly, it is possible to perform printing such that printing images are arranged in the front-rear direction of the printing medium. When the motor 6 is driven by being controlled by the CPU 27A, the braking apparatus 6A is in the electrical conduction state and the brake on the motor 6 is inactive. The braking apparatus 6A thus does not prevent the rotation of the motor 6.

After completion of printing, when the printing system 8 is switched to the turn-off state, the braking apparatus 6A becomes the non-electrical-conduction state and the brake on the motor 6 becomes active. This prevents the movement in the front-rear direction of the printing apparatus 1. For example, the user can remove the ribbon cartridge 9 from the printing apparatus 1 by moving the ribbon cartridge 9 frontward relative to the printing apparatus 1 in the state where the brake on the motor 6 is active. Since the braking apparatus 6A prevents the movement in the front-rear direction of the printing apparatus 1, the printing apparatus 1 does not move frontward even when force caused by removal of the ribbon cartridge 9 acts thereon.

### Action and Effect of this Embodiment

The printing apparatus 1 performs printing on the printing medium by heating the ink ribbon 9A by the thermal head 26 while moving in the front-rear direction by the actuator 5 and the motor 6. In the electrical conduction state of the braking apparatus 6A capable of braking the motor 6, the brake on the motor 6 is inactive. In that configuration, when the printing apparatus 1 performs printing in a state where the printing system 8 is turned on, the braking apparatus 6A is in the electrical conduction state and the movement of the printing apparatus 1 is not prevented by the braking apparatus 6A. In the non-electrical-conduction state of the braking apparatus 6A, the brake on the motor 6 is active. In that configuration, for example, when the printing system 8 is turned off, the printing apparatus 1 is prevented from moving in the front-rear direction. Namely, a user can install or remove the ribbon cartridge 9 in or from the printing apparatus 1 in the state where the movement of the printing apparatus 1 is prevented, for example, when the printing system 8 is turned off. The user has difficulty in installing or removing the ribbon cartridge 9 in or from the printing apparatus 1 if the printing apparatus 1 is moved by the force caused by the installation or removal of the ribbon cartridge 9. In the printing system 8, however, the movement of the printing apparatus 1 during the installation or removal of the ribbon cartridge 9 is prevented, allowing the user to appropriately install or remove the ink ribbon 9A in or from the printing apparatus 1.

In a state where no printing is performed by the printing apparatus 1, the CPU 27A mounted on the control board 27 of the printing apparatus 1 controls the driver elements to make the motor 6 have the electrical conduction state and to excite the motor 6. In that case, great static torque is generated on the motor 6 in the state where no printing is performed by the printing apparatus 1, preventing the movement in the front-rear direction of the printing apparatus 1. Accordingly, when the printing apparatus 1 performs no printing, the user can install or remove the ink ribbon 9A in or from the printing apparatus 1 in the state where the movement of the printing apparatus 1 is prevented. This allows the user to appropriately install or remove the ink ribbon 9A in or from the printing apparatus 1.

In the printing system 8, the moving direction (front-rear direction) of the ribbon cartridge 9 when the ribbon cartridge 9 is installed in or removed from the printing apparatus 1 is parallel to the moving direction (the front-rear direction) of the printing apparatus 1 moved by the actuator 5 and the motor 6. In that configuration, the printing apparatus 1 easily moves in the front-rear direction due to the force caused by the installation or removal of the ribbon cartridge 9. In this embodiment, however, the brake on the motor 6 is active in the non-electrical-conduction state of the braking apparatus 6A. The printing system 8 is thus capable of preventing the printing apparatus 1 from moving in the front-rear direction during the installation or removal of the ribbon cartridge 9, even when the moving direction of the ribbon cartridge 9 during the installation or removal of the ribbon cartridge 9 is parallel to the moving direction of the printing apparatus 1.

The actuator 5 includes the lead screw 52 coupled to the rotation shaft of the motor 6. The pitch of the lead screw 52 is larger, as the moving speed of the printing apparatus 1 that moves depending on the rotation of the motor 6 is faster. The printing apparatus 1 receiving external force may move in the front-rear direction. In that case, the printing apparatus 1 can move with weaker force, as the pitch of the lead screw 52 is larger. Namely, if the pitch of the lead screw 52 is larger to increase the moving speed of the printing apparatus 1 in the front-rear direction, the printing apparatus 1 more easily moves during the installation or removal of the ribbon roll 90 with respect to the printing apparatus 1. Meanwhile, in the non-electrical-conduction state of the braking apparatus 6A, the brake on the motor 6 is active to prevent the movement in the front-rear direction of the printing apparatus 1. Accordingly, the printing system 8 can move the printing apparatus 1 at high speed by making the pitch of the lead screw 52 large, and can prevent the printing apparatus 1 from moving in the front-rear direction during the installation or removal of the ribbon cartridge 9 with respect to the printing apparatus 1.

In the printing system 8, the electromagnetic brake is used as the braking apparatus 6A, making it possible to prevent the rotation of the motor 6. In that case, the braking apparatus 6A is capable of easily switching between the brake active state and the brake inactive state on the motor 6 depending on whether the braking apparatus 6A is electrically conducted.

### Modified Embodiment

The present disclosure is not limited to the above embodiment, and the present disclosure may include various modifications of the above embodiment. The printing apparatus 1 is not limited to the configuration in which the ribbon cartridge 9 is installed therein or removed therefrom. For example, a ribbon roll wound around a spool may be directly installed in or removed from the installation portions 22A and 22F. The actuator 5 may not include the configuration formed by the lead screw 52 and the ball screw 52A. For example, the actuator 5 may include a pinion gear coupled to the rotation shaft of the motor 6 and a lack gear movable in the front-rear direction depending on the rotation of the pinion gear. In that configuration, the printing apparatus 1 may be connected to the lack gear. The braking apparatus 6A braking the motor 6 is not limited to the electromagnetic brake. For example, the braking apparatus 6A may be an electromagnetic clutch disposed between the rotation shaft of the motor and a brake. In the non-electrical-conduction state of the braking apparatus 6A, coupling of the electromagnetic clutch may make the brake on the motor 6 active. In the electrical conduction state of the braking apparatus 6A, disengagement of the electromagnetic clutch may make the brake on the motor 6 inactive.

The motor 6 may be controlled by any other device than the CPU 27A of the control board 27 of the printing apparatus 1. For example, the printing system 8 may include a controller (e.g., a control box provided in the printing system 8) driving the motor 6. This controller may make the motor 6 have the non-electrical-conduction state when no printing is performed by the printing apparatus 1.

The moving direction of the ribbon cartridge 9 relative to the printing apparatus 1 during the installation or removal of the ribbon cartridge 9 with respect to the printing apparatus 1 may not be parallel to the moving direction of the printing apparatus 1, provided that the moving direction of the ribbon cartridge 9 intersects with the moving direction of the printing apparatus 1.

The CPU 27A of the control board 27 is an exemplary controller of the present disclosure. The left-right direction is an exemplary conveyance direction of the present disclosure. The front-rear direction is an exemplary intersecting direction of the present disclosure.

What is claimed is:

1. A printing system configured to perform printing on a printing medium conveyed in a conveyance direction, the printing system comprising:
a printing apparatus including an installation portion in which an ink ribbon is removably installed, and a thermal head configured to heat the ink ribbon installed in the installation portion;
a motor;
an actuator coupled to the motor and configured to move the printing apparatus, depending on drive of the motor, in an intersecting direction intersecting with the conveyance direction; and
a braking apparatus configured to brake rotation of the motor, wherein the brake on the motor is active in a non-electrical-conduction state of the braking apparatus and the brake on the motor is inactive in an electrical conduction state of the braking apparatus.

2. The printing system according to claim 1, further comprising a controller configured to excite the motor in a state where no printing is performed by the printing apparatus.

3. The printing system according to claim 1, wherein a moving direction of the ink ribbon in a case that the ink ribbon is being installed in or removed from the printing apparatus is parallel to the intersecting direction.

4. The printing system according to claim 1, wherein the actuator includes a lead screw which is coupled to a rotation shaft of the motor.

5. The printing system according to claim 1, wherein the braking apparatus is an electromagnetic brake.

6. The printing system according to claim 4, wherein the lead screw extends in the intersecting direction,
the actuator includes a ball screw screwed with the lead screw, and
the printing apparatus includes a coupling portion coupled to the ball screw.
